(19) United States
(12) Patent Application Publication
(10) Pub. No.: US 2024/0211330 A1
(43) Pub. Date: Jun. 27, 2024

(54) LOG ENTRY ANALYSIS IN MANAGED ENDPOINTS

(71) Applicant: Ivanti, Inc., South Jordan, UT (US)

(72) Inventor: Paul Branton, South Jordan, UT (US)

(73) Assignee: Ivanti, Inc., South Jordan, UT (US)

(21) Appl. No.: 18/069,951

(22) Filed: Dec. 21, 2022

(51) Int. Cl. G06F 11/07

(52) U.S. Cl. CPC G06F 11/0766; G06F 11/079

(57) ABSTRACT

A method may include monitoring a log file at an endpoint of a managed network, and an error log entry that indicates a technical error experienced at the endpoint may be identified. The method may include ignoring the log entries that are generated during a first time period following identification of the error log entry. A first set of log entries may be collected during a first time interval beginning at the end of the first time period and going back a second time period. A second set of log entries may be collected during a second time interval beginning at the end of the first time period and moving forward for a third time period. The first and second sets of log entries may be aggregated, and a mitigation action determined based on analysis of the aggregated log entries may be implemented as a solution to the technical error.

### FIELD OF THE INVENTION

The present disclosure generally relates to automated diagnosis and management of network connected computing devices. In particular, some embodiments relate to log entry analysis in managed endpoints.

### BACKGROUND

A computing systems such as endpoints in managed networks may generate log files during performance of computer operations or after the conclusion of some or all of the computer operations. The log files are data files that include a series of log entries in which information regarding the operations are recorded. For instance, log entries may include operation-startup information, system-change information, unexpected-shutdown messages, error-occurrence messages, error-identification messages, some combination thereof, or any other details relating to the computer operations.

The log files may be collected and analyzed by a user of the computing system or an administrator of computer network with which the computing system communicates. Analysis of the log files may provide insight into operation of the computing system, which may enable diagnosis of events or operational problems experienced during computer operations.

In some systems, the log files are not maintained or stored by the computing system. For instance, in some Apple® operating systems (e.g., iOS) log entries are continuously fed into the log file, a combination of in memory and on disk storage. The log file is maintained at a particular size by deleting the oldest log entry before adding the newest, the in memory storage being cleared first. Debug and information log entries, by default, are stored in memory only and are hence the first to be deleted by the system. Accordingly, a delay between report of an operational problem and the analysis of the log file may result in log entries related to the operational problem being deleted or being otherwise unavailable.

Moreover, an amount of log entries, especially in complex computing systems, may inhibit effective analysis. For instance, log entries related to the operational problem may be separated by tens or hundreds of irrelevant log entries. Accordingly, analysis of a raw log file may involve substantial processing with inaccurate or disparate data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include monitoring a log file at an endpoint of a managed network in which the log file includes log entries generated by the endpoint. While monitoring the log file, an error log entry that indicates a technical error is experienced at the endpoint may be identified. The method may include ignoring the log entries that are generated during a first time period following identification of the error log entry. After the first time period, a first set of log entries may be collected during a first time interval from the endpoint in which the first time interval begins at the end of the first time period and goes back a second time period. A second set of log entries may be collected during a second time interval from the endpoint in which the second time interval begins at the end of the first time period and moves forward for a third time period. The first and the second set of log entries may be aggregated, and a mitigation action may be received from an administrative device. The mitigation action, which may be based on an analysis of the aggregated log entries and determination of a solution to the technical error, may be implemented at the endpoint.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIGS. 1A and 1B are diagrams of example operating environments in which some embodiments of the present disclosure may be implemented.

FIG. 2 depicts an example log file collection process that may be implemented in the operating environments of FIGS. 1A and 1B or another suitable environment.

FIG. 3 is a flow chart of an example method of log entry analysis in managed endpoints, according to at least one embodiment of the present disclosure.

FIG. 4 illustrates an example computing system configured for log file collection and/or analysis according to at least one embodiment of the present disclosure.

FIG. 5 illustrates an example log entry that may be implemented in the operating environments of FIGS. 1A and 1B;

FIGS. 6A-6B is an example log file in which some log entries are collected according to the process collected log entries according to at least one embodiment of the present disclosure.

### DETAILED DESCRIPTION

A reviewing user or information technology (IT) administrator may analyze log files to identify whether a computer network or an endpoint managed in the computer network are experiencing operational problems. Specific patterns of computer operations recorded in the log files may be indicative of normal operation, while other patterns of computer operations may suggest or expressly indicate abnormal operation. Accordingly, analysis of specific, related log entries within the log file may enable diagnosis and remediation of causes of abnormal operation. However, log files in conventional computing systems do not allow intelligent collection of log entries related to abnormal operations. Thus, embodiments of the present disclosure relate to systems and methods of collecting portions of log files related to error log entries, analysis of the portions of log files, remediation of abnormal operation, or combinations thereof.

For example, a user of a computing device, such as a managed endpoint, may notify a reviewing user or IT administrator of a technical issue experienced on the computing device. The reviewing user may manually retrieve a log file documenting computer operations potentially relevant to the technical issue. For instance, the log file may include logs documenting information of application and hardware operations at or around the time of the technical issue.

Some conventional logfile analysis systems may include tools that assist the reviewing user in organizing and reviewing log files. For example, some conventional log analysis systems may include machine-learning tools that make preliminary assessments regarding computer network behavior before notifying the reviewing user of suspected problems arising with the computer network.

Accurate diagnosis of computer network problems via log file analysis ultimately relies on the computers of the computer network having robust log file recording processes. Additionally or alternatively, the log file analysis may entail parsing through large quantities of log files that may or may not be relevant to a particular error report to identify the log files that relate to a particular error report or topic of interest to the reviewing user. Striking a balance between recording too few and too many log files may be further complicated because different operating systems may include different procedures for recording log files. For example, macOS® typically deletes log files quickly such that a particular log file documenting an error may be deleted by the time the error is reported via a ticketing system. Consequently, identifying and/or analyzing errors via log file analysis on computers that include macOS operating systems may be difficult due to the lack of available information in the log files. As an additional or alternative example, MICROSOFT WINDOWS® operating systems usually stores the recorded log files and never deletes them, which may result in a large number of log files being reviewed before a relevant error is identified.

Embodiments of the present disclosure relate to systems and methods of monitoring and collecting log files to facilitate log file analysis in a computer network environment. The computer network may include computers communicatively coupled with each other over a communication network in which each computer included in the computer network operates using the same or different operating systems. Consequently, the computers included in the computer network may or may not generate log files according to consistent operation logging policies. In response to experiencing an error or other operational abnormality, a particular computer included in the computer network may automatically send an error report to a system administrator over the communication network. Additionally or alternatively, an end user of the particular computer may manually send the error report or otherwise requests assistance with computer operations from the system administrator over the communication network.

A log file monitoring and collection process according to the present disclosure may involve waiting a first period of time after receiving an error report from the particular computer. The log file monitoring and collection process may include collecting a first set of log messages going back a second period of time from a particular computer after obtaining the error report and waiting the first period of time. A second set of log messages may be collected from the particular computer over a third period of time after waiting the first period of time. The first set of log messages and the second set of log messages may be analyzed to determine a solution to the error described in the error report.

For example, an end user may send an error report to a system administrator associated with a managed computer network, and a log-filing system according to the present disclosure may trigger a particular first period of time, such as ten seconds, after the system administrator receives the error report. The log-filing system may then review a first set of log files collected going back a second period of time, such as ten minutes, and begin collecting a second set of log files over a third period of time, such as over the next ten minutes. In this and other examples, the second period of time may or may not be equal in length to the third period of time.

Additionally, in some embodiments, the first set of log messages and/or the second set of log messages may be filtered before, during, or after collection by the log-filing system. For example, the first set of log messages and/or the second set of log messages may be filtered or sorted based on text included in the log messages relating to event categories, urgency levels, event domains, originating applications, message prefixes, post identification numbers, thread identification numbers, time of generation of the log messages, some combination thereof, or any other log message details. In these and other embodiments, the second set of log messages may be filtered or sorted using one or more of the same or similar criteria used to filter or sort the first set of log messages.

Additionally, in some embodiments, the first set of log messages and the second set of log messages may be aggregated after being filtered and sent to the user who received the error report for analysis. The user may include a software developer, a system administrator, or any other IT person who operates another endpoint included in the computer network with which the particular computer that sent the error report communicates. Additionally or alternatively, the computer network may send the aggregated log messages to a cloud computer system so that a third-party user may review and analyze the aggregated log messages. Additionally or alternatively, the user may include a machine-learning system or other artificial intelligence engine that is configured to identify operational errors and/or propose solutions to operational errors based on log messages obtained by the machine-learning system.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of some example configurations of the systems and methods.

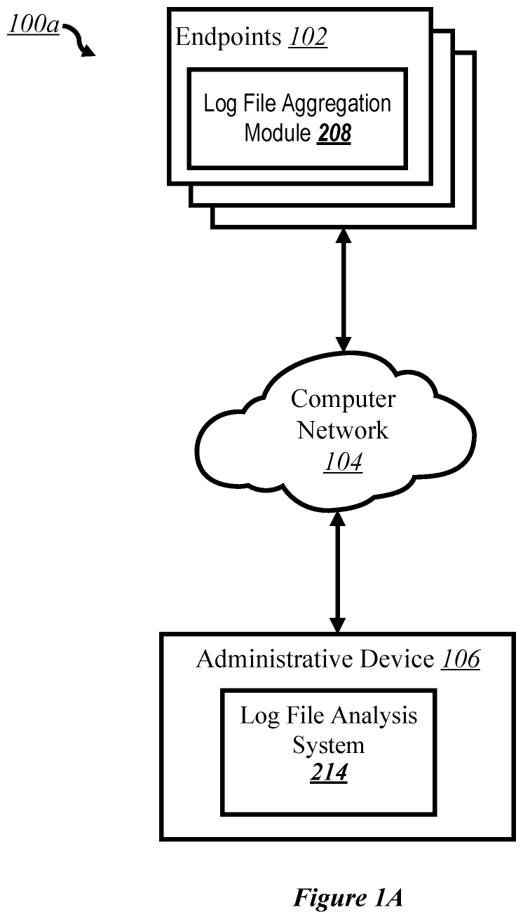

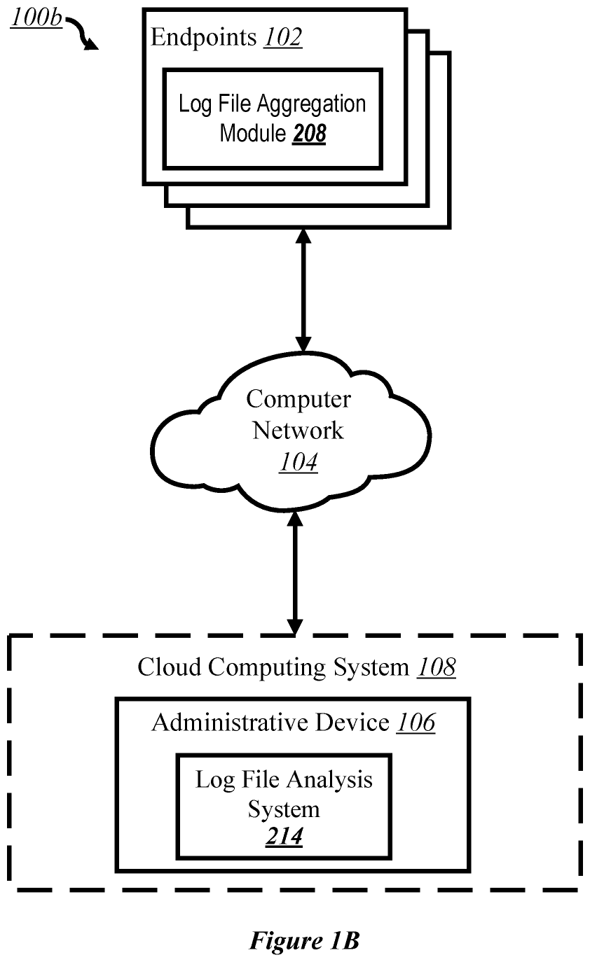

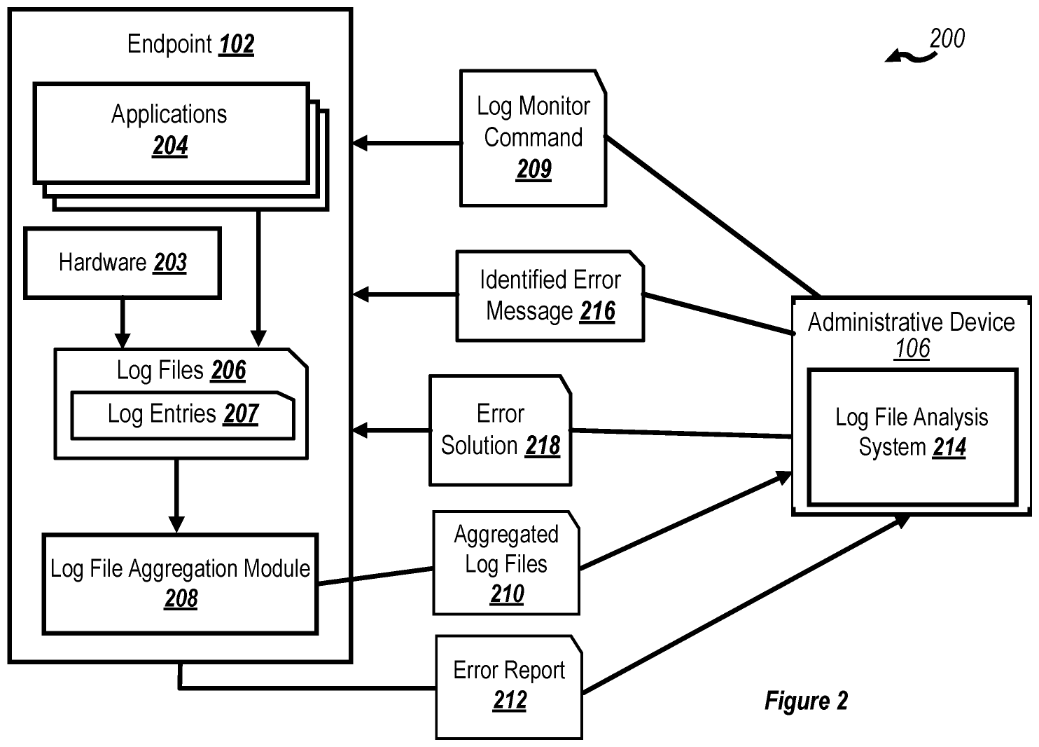

FIGS. 1A and 1B are diagrams of a first example operating environment 100a and a second example operating environment 100b (collectively referred to herein as “operating environments 100”) in which some embodiments of the present disclosure may be implemented. The operating environments 100 of FIGS. 1A and 1B include one or more endpoints 102 and an administrative device 106 that are communicatively coupled with one another over a computer network 104. A particular endpoint 102 may send information to and receive information from one or more other endpoints 102 that are also connected via the computer network 104. For example, the endpoints 102 may include desktop computers, laptop computers, mobile devices, Internet of Things devices, some combination thereof, or any other computers that are configured to communicate with the computer network 104. In some embodiments, a particular user may be associated with a particular endpoint 102. For example, a first user may be associated with a first endpoint 102 by logging onto the first endpoint 102 using log-in credentials specific to the first user, and/or the first endpoint 102 may be assigned to the first user based on a role and/or function of the first endpoint 102. The endpoints 102 may include log file aggregation modules 208, which are configured to aggregate log entries generated by the endpoints 102 as a log file that may be sent to one or more other computers using the computer network 104. Operations of the log file aggregation module 208 are described in further detail in relation to a log file communication process 200 of FIG. 2 below.

The computer network 104 may include one or more wide area networks (WANs) and/or local area networks (LANs) that enable the endpoints 102 and/or the administrative device 106 of the operating environments 100 to communicate with each other. In some embodiments, the computer network 104 may include the Internet in which communicative connectivity between the components of the operating environments 100 is formed by logical and physical connections between multiple WANs and/or LANs. Additionally or alternatively, the computer network 104 may include one or more cellular radio frequency (RF) networks, one or more wired networks, one or more wireless networks (e.g., 802.xx networks), Bluetooth access points, wireless access points, Internet Protocol (IP)-based networks, or any other wired and/or wireless networks. The computer network 104 may also include servers that enable one type of network to interface with another type of network.

The administrative device 106 may include a log file analysis system 214 that is configured to obtain log files from one or more of the endpoints 102 and perform analysis using the log entries included in the log files to identify a technical problem and/or determine a solution to the technical problem being experienced by one or more of the endpoints 102. In some embodiments, the administrative device 106 may include a computer that is the same as or similar to the endpoints 102. For example, the administrative device 106 may include a computer operated by a system administrator, technical support user, an IT consultant, or any other users, and the administrative device 106 may be configured to communicate with the endpoints 102 over the computer network 104.

Additionally or alternatively, the administrative device 106 may be included as part of a cloud computer system 108 that is configured to communicate with one or more of the endpoints 102 over the computer network 104 as illustrated in the second example operating environment 100b of FIG. 1B. The cloud computer system 108 may include a separate computer network that is configured to communicate with the computer network 104 with which the endpoints 102 are associated. The administrative device 106 may include a particular computer that is communicatively coupled with the cloud computer system 108 but not communicatively coupled with the computer network 104. In these and other embodiments, the endpoints 102 may send their respective log files relating to any technical problems being experienced by one or more of the endpoints 102 to the cloud computer system 108 via the computer network 104, and the cloud computer system 108 may send the received log files to the administrative device 106.

Additionally or alternatively, although illustrated as being included with the endpoints 102 and the administrative device 106, respectively, the log file aggregation module 208 and the log file analysis system 214 may be included in the operating environments 100 as computing devices separate from the endpoints 102 or the administrative device 106. For example, the log file aggregation module 208 may be included as part of a separate computing device that is configured to provide instructions and/or software that facilitate aggregation of log entries from one or more of the endpoints 102 as a log file as described in further detail below in relation to the log file communication process 200 of FIG. 2.

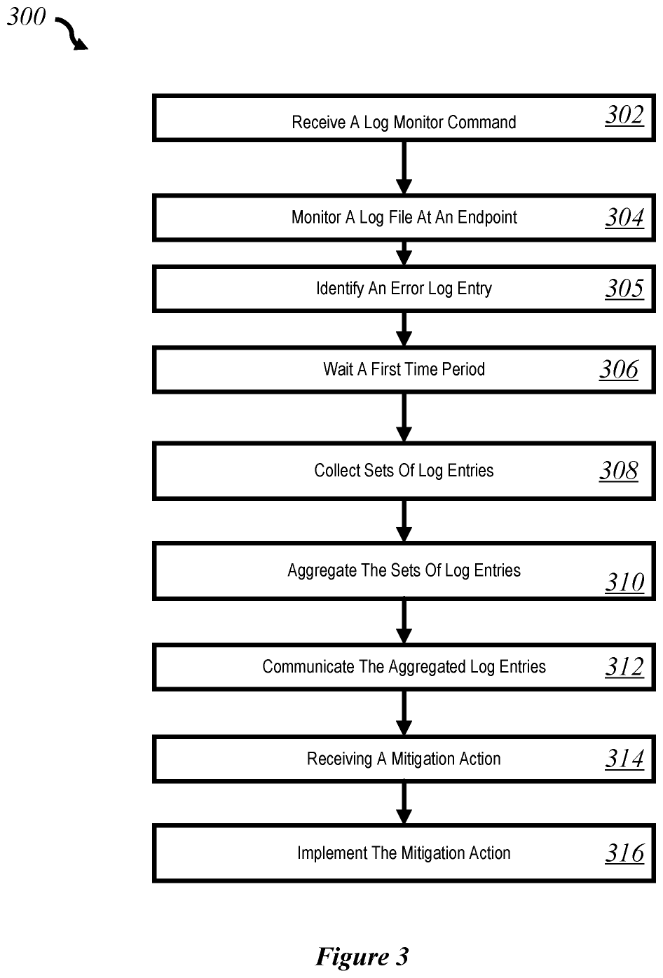

In some embodiments, the administrative device 106, rather than or in addition to the endpoints 102, may be configured to determine whether one or more of the endpoints 102 are experiencing any errors during operation. The administrative device 106 may be configured to communicate a program to an endpoint 102 that is experiencing an error in which the program includes code and/or routines that facilitate collecting log files as described in relation to a log file communication process 200 of FIG. 2 and/or a method 300 of FIG. 3 below. The program relating to log file collection may involve creating a folder local to a particular endpoint 102 from which the log files are being collected, and the administrative device 106 may be configured to monitor the created folder and retrieve aggregated log files from the folder.

Modifications, additions, or omissions may be made to the operating environments 100 without departing from the scope of the present disclosure. For example, the designations of different elements in the manner described is meant to help explain concepts described herein and is not limiting. For instance, in some embodiments, the endpoints 102, the computer network 104, the administrative device 106, and/or the cloud computer system 108 are delineated in the specific manner described to help with explaining concepts described herein but such delineation is not meant to be limiting. Further, the operating environments 100 may include any number of other elements or may be implemented within other systems or contexts than those described.

FIG. 2 depicts an example log file collection process (process) 200 that may be implemented in the operating environments 100a and 100b of FIGS. 1A and 1B or another suitable environment. The process 200 of FIG. 2 is between one of the endpoints 102 of FIGS. 1A and 1B and the log file analysis system 214 of the administrative device 106. Although not depicted in FIG. 2, the administrative device 106 may be included in a cloud computing system such as the cloud computing system 108 of FIG. 1B. Also, although not depicted, it may be understood that communication of data and information in the process 200 may be via a network such as the computer network 104 of FIGS. 1A and 1B.

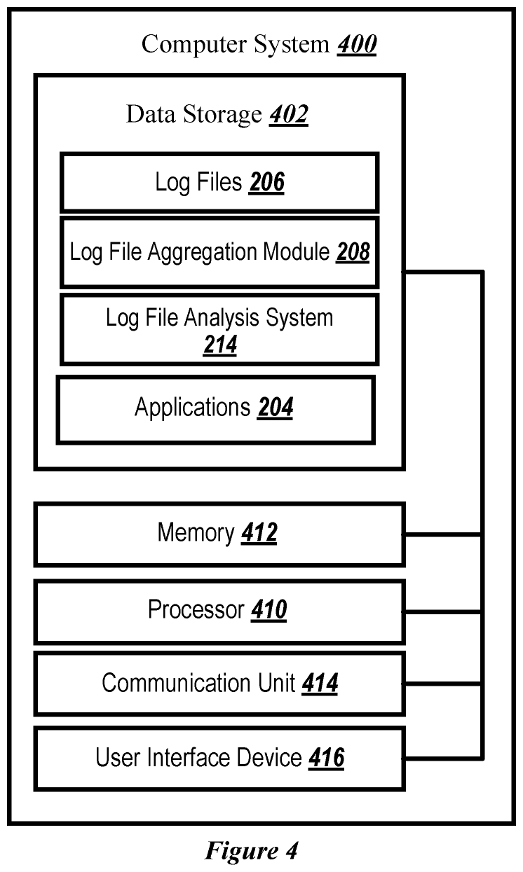

The endpoint 102 of FIG. 2 may be configured to perform instructions relating to operations of one or more applications 204 and hardware 203. The applications 204 include any software that may be installed and provide instructions that may be performed by the endpoint 102. For example, the applications 204 may include web browsers, information worker software (e.g., data management applications, word processors, email services, enterprise resource planning software, and/or financial software), enterprise infrastructure software (e.g., database management software, business workflow software, geographic information systems, and/or digital asset management software), some combination thereof, or any other application software. The hardware 203 may include processors (e.g., processors 410 of FIG. 4), memory (e.g., memory 412 of FIG. 4), communication unit (e.g., communication unit 414), a user interface device (e.g., user interface device 416), combinations thereof or other suitable hardware.

The endpoint 102 may be configured to generate a log file 206. The log file 206 includes log entries 207 that describe an operation associated with one or more of the applications 204 and/or the hardware 203. The endpoint 102 may be configured to generate log entries 207 in response to specific pre-classified events occurring during operation of the endpoint 102. For example, one of the applications 204 crashing may trigger the endpoint 102 to generate one of the log entries 207 that indicates the particular application 204 has experienced an error during operation, or more specifically, that the particular application 204 has crashed.

In these and other embodiments, the operations that trigger entries in the log file 206, the formatting of the log file 206, the contents of the log file 206, some combination thereof, or any other characteristics or parameter relating to the log file 206 may be determined by a log-file-generation protocol. The log-file-generation protocol may be based on one of the applications 204 such as the operating system of the endpoint 102. For instance, an embodiment of the endpoint 102 that implements MICROSOFT WINDOWS® operating systems may prompt generation of the log file 206 based on a first set of operations while an embodiment of the endpoint 102 that implements macOS® operating systems may prompt generation of the log file 206 based on a second, different set of operations.

The log file 206 may include text data in the form of log entries 207. Each of the log entries 207 include information relating to a particular operation performed by the endpoint 102. The information recited in the log entries 207 may include, for example, computer system information about the endpoint 102, version information about the particular application 204 to which the particular log file 206 corresponds, descriptions of the particular operation, identification information about any errors that occurred during performance of the particular operation, a time at which the particular operation was performed, a location of any files associated with the particular operation and/or the particular application 204, some combination thereof, or any other information relating to the particular operation.

In some embodiments of the process 200, the endpoint 102 may send an error report 212 to the log file analysis system 214 of the administrative device 106. In some embodiment, the error report 212 may include a ticket submitted by a user associated with the endpoint 102. The ticket may indicate the user has experienced a technical issue during operation of the endpoint 102. Additionally or alternatively, the error report 212 may include an automatically generated notification such as an error report generated by one of the applications 204 responsive to the endpoint 102 experiencing a technical problem during operation.

The error report 212 may be submitted via a computer network, such as the computer network 104 of FIGS. 1A and 1B. Additionally or alternatively, the error report 212 may be communicated outside the computer network. For example, the error report 212 may include a message sent by a user associated with the endpoint 102 to another user such as an administrator who has access to the administrative device 106. As an additional or alternative example, the error report 212 may include a text file that is generated in response to an error occurrence during operations of the endpoint 102 and may be sent automatically to the log file analysis system 214 for review.

Responsive to the error report 212, the administrative device 106 may communicate a log monitor command 209 to the endpoint 102. The log monitor command 209 may include a button or icon selected at the administrative device 106 or the log file analysis system 214 that triggers a log file aggregation module 208 to start to monitor the log file 206. Monitoring the log file 206 includes a reading and parsing new instances of the log entries 207 as they are added to the log file 206.

In some embodiments, the log monitor command 209 may include on or more parameters by which the log entries 207 may be filtered. For instance, the parameter may include an event category, an urgency level, an event domains, one of the applications 204, a message or log prefix, a post identification number, a thread identification number, a time corresponding to the log entry, another parameter, or combinations thereof.

After the log monitor command 209 is received, the log file aggregation module 208 may begin to monitor the log file 206. While monitoring the log file 206, the log file aggregation module 208 may identifying an error log entry that indicates a technical error is experienced at the endpoint 102. In some embodiments, the technical error related to the error log entry may be related to or identical to technical issue of the error report 212. For instance, the error report 212 may be related to a first application of the applications 204 and the identified error log entry may be an error in the operation of the first application. Identification of the error log entry may trigger a collection of a portion of the log file 206.

In some embodiments, the log file aggregation module 208 may collect the log entries 207 during one or more intervals surrounding a time at which the identified error log entry is generated. The log file aggregation module 208 may collect the log entries 207 of the log file 206 going back a time period and moving forward a time period. For instance, the time period may be five minutes and the error log entry may be identified at 12:00 PM. Accordingly, the log entries 207, or some portion thereof, from 11:55 AM-12:05 PM may be collected.

In some embodiments, the time periods during which the log entries 207 are collect may be different. For instance, the log file aggregation module 208 may collect the log entries 207 of the log file 206 going back a first time period (e.g., 3 minutes) and moving forward a second time period (e.g., 5 minutes). In other embodiments, the time periods may be equal or substantially equal. In these and other embodiments, the time periods may be set according to a characteristic of the endpoint. For example, the first time period and/or the second time period may be set to be longer for endpoints that include macOS® operating systems to collect a greater number of log entries 207 for analysis. As an additional or alternative example, the first time period and/or the second time period may be set to be shorter for endpoints that include WINDOWS® operating systems to decrease the number of log entries 207 collected for analysis.

Additionally, the log file aggregation module 208 may wait for a time period immediately after identification of the error log entry prior to collection of log entries 207. In some circumstances a single technical issue may result in generation of several error log entries within a short period of time. Accordingly, waiting for a time period following identification of the error log entry may reduce the likelihood of recording duplicate error log entries related to one technical issue. During the time period in which the log file aggregation module 208 waits, the log entries may be ignored. In these and other embodiments, time intervals during which the log entries 207 are collected may be based on the end of the time period that the log file aggregation module 208 waits. For instance, the collection time periods may be five minutes, the wait time period may be thirty second, and the error log entry may be identified at 12:00:00 PM. Accordingly, the log file aggregation module 208 may wait until 12:00:30 PM and the log entries 207 or portions thereof may be collected from 12:00:30 PM until 12:05:30 PM and from 11:55 AM until 12:00. Alternatively, the log file aggregation module 208 may wait until 12:00:30 PM and the log entries 207 or portions thereof may be collected from 11:55:30 AM until 12:05:30 PM, with the log entries from the wait time interval being omitted.

In these examples, collection of log entries 207 going backward may be pulled from the log file 206. Collection of the log entries 207 moving forward may be pulled as the log entries 207 are generated or as the log entries 207 are added to the log file 206.

The log file aggregation module 208 may aggregate collected log entries as aggregated log files 210. The log file aggregation module 208 may compile the log files 206 as an archive file, such as using a .zip file, a .rar file, a .7z file, a .tar file, or using another suitable archive file format. Additionally or alternatively, the log file aggregation module 208 may present the aggregated log files 210 using a spreadsheet, a text file, a vector, or any other form of data aggregation.

In some embodiments, the log file aggregation module 208 may communicate the aggregated log files 210 to the administrative device 106. For instance, the log file aggregation module 208 may communicate the aggregated log files 210 to a particular location (e.g., a particular storage location or IP address). The administrative device 106 may monitor the particular location for the aggregated log files 210. After the aggregated log files 210 are detected at the particular location, the log file analysis system 214 may analyze the aggregated log files 210 as detailed elsewhere in the present disclosure.

In some embodiments, the aggregated log files 210 may not include every one of the log entries 207. For instance, the log monitor command 209 may include one or more parameters. The parameters may be used to filter collected log entries 207 that are included in the aggregated log files 210. In some embodiments, the log file aggregation module 208 may only collect the log entries 207 that include the parameters. Additionally or alternatively, the log file aggregation module 208 may only aggregate into the aggregated log files 210 the log entries 207 that include the parameters. Some examples of the parameters may include an event category, an urgency level, an event domain; an application 204 referenced in the log entries 207, a message or a log prefix, a post identification number, a thread identification number, a time corresponding to the log entry, or combinations thereof.

The log file analysis system 214 may be configured to analyze the aggregated log files 210. Part of the analysis may include identification of a technical issue being experienced at the endpoint 102. For instance, the log file analysis system 214 may be configured to identify the basis of the error report 212 and the identified error log entry. To identify the technical issue, patterns or sequences of log entries may be recognized and compared to known sequences of the log entries related to a previously experienced technical issue. Additionally or alternatively, an IT administrator may review the aggregated log files 210 to troubleshoot and diagnosis the technical issue. In these and other embodiments, the log file analysis system 214 may reduce a number of log entries to review and may provide insights related to the diagnosis. Additionally or alternatively still, the log file analysis system 214 may implement a machine-learning system or other artificial intelligence processes that are configured to receive the aggregated log files 210 as inputs and output one or more proposals for the technical error.

The log file analysis system 214 may communicate an identified error message 216. The identified error message 216 may be communicated to the endpoint 102 in some embodiments. The endpoint 102 may cause display of the identified error to a user of the endpoint 102.

The log file analysis system 214 may determine a solution to the identified error. For instance, for some technical issues, a solution may include re-installing or updating one of the applications 204 or modifying a setting or operational parameter of one of the applications 204 and/or the hardware 203. Additionally or alternatively, the log file analysis system 214 may implement a machine-learning system or other artificial intelligence processes that are configured to receive the aggregated log files 210 as inputs and output one or more proposed solutions with respect to the identified error message 216 and/or the error solution message 218. In some embodiments, the log file analysis system 214 may implement a machine-learning system or other artificial intelligence processes that are configured to receive the aggregated log files 210 and the identified error as inputs and output one or more proposed error solutions.

The log file analysis system 214 may communicate an error solution message 218 (in FIG. 2, “error solution 218”). The error solution message 218 may identify the error solution and may include a command to remotely implement the error solution.

In some embodiments, the log file analysis system 214 may involve a dashboard that organizes the information pertaining to the aggregated log files 210, the error report 212, the identified error of the identified error message 216, the error solution of the error solution message 218, or combinations thereof. The dashboard may visually depict to a user of the endpoint or an IT analyst.

In some embodiments, the log file aggregation module 208 may be implemented as part of the endpoint 102 as illustrated in FIG. 2. Additionally or alternatively, the log file aggregation module 208 may be implemented as part of one or more other endpoints with which the endpoint 102 communicates and/or as part of a log file analysis system 214. In situations in which the log file aggregation module 208 is not implemented as part of the endpoint 102, the log files 206 generated during operation of the endpoint 102 may be sent to the computer that implements the log file aggregation module 208 to generate the aggregated log files 210.

The endpoint 102, the applications 204, the log file aggregation module 208, the log file analysis system 214, components thereof, and combinations thereof may be implemented using hardware including a processor, a microprocessor (e.g., to perform or control performance of one or more operations), a field-programmable gate array (FPGA), or an application-specific integrated circuit (ASIC). In some other instances, the endpoint 102, the applications 204, the log file aggregation module 208, the log file analysis system 214, combinations thereof, and components thereof may be implemented using a combination of hardware and software. Implementation in software may include rapid activation and deactivation of one or more transistors or transistor elements such as may be included in hardware of a computing system. Additionally, software defined instructions may operate on information within transistor elements. Implementation of software instructions may at least temporarily reconfigure electronic pathways and transform computing hardware.

Modifications, additions, or omissions may be made to the process 200 without departing from the scope of the present disclosure. For example, the designations of different elements in the manner described is meant to help explain concepts described herein and is not limiting. For instance, in some embodiments, the endpoint 102, the applications 204, the log file aggregation module 208, and the log file analysis system 214 are delineated in the specific manner described to help with explaining concepts described herein but such delineation is not meant to be limiting. Further, the process 200 may involve or be implemented by one or more additional elements or may be implemented within other systems or contexts than those described.

FIG. 3 is a flow chart of an example method 300 of log entry analysis in managed endpoints, according to at least one embodiment of the present disclosure. The method 300 may be performed in a suitable operating environment such as the operating environments 100 of FIGS. 1A and 1B. One or more operations of the method 300 may be performed by a computing device such as the endpoints 102, the computer network 104, the administrative device 106, and/or the cloud computer system 108.

The method 300 may begin at block 302 in which a log monitor command may be received. The log monitor command may be configured to initiate monitoring of the log file at an endpoint. The endpoint may be a part of a managed endpoint in some embodiments. In some embodiments, the log monitor command may be received from an administrative device in response to an error report that indicates an occurrence of a technical error at the endpoint.

The error report may be generated and sent by a user of the endpoint. Additionally or alternatively, the error report may be autonomously generated by the endpoint in response to particular events occurring during performance of operations on the endpoint, such as experiencing a runtime error, overusing computer resources, input errors, some combination thereof, or another event that may be flagged as being abnormal by the endpoint. In some situations, the error report may be generated because a technical issue is detected, but the cause of the technical issue may not be readily identifiable. For example, it may be difficult to immediately determine that slow runtime and/or crashing of a particular application is caused by a memory leak.

At block 304, a log file may be monitored. The log file at the endpoint may be monitored. At block 305, an error log entry may be identified. For instance, while monitoring the log file, the error log entry may be identified. The error log entry may indicate a technical error is experienced at the endpoint.

At block 306, the method 300 may include waiting a first time period. For instance, following identification of the error log entry of block 305, log entries may be ignored or a system implementing the method 300 may wait for the first time period. The first time period may be configured to reduce one or more duplicate error logs associated with the technical error. Accordingly, log entries may be ignored (e.g., not collected) during the first time period.

In some embodiments, a time may be recorded at which the error log entry of block 305 is identified, which may initiate the waiting based on the recorded time. The first time period may be 2 seconds, 5 seconds, 10 seconds, 20 seconds, 30 seconds, 1 minute, 2 minutes, 5 minutes, or another period of time.

At block 308, one or more sets of log entries may be collected. The one or more sets of log entries may be collected from the endpoint during one or more time intervals. For instance, after the first time period a first set and a second set of log entries may be collected. The first set of log entries may be collected during a first time interval. The first time interval may begin at the end of the first time period and go back a second time period. Additionally, a second set of log entries may be collected during a second time interval. The second time interval may begin at the end of the first time period and move forward for a third time period.

In some embodiments, lengths of the first time period, the second time period, and/or the third time period (collectively referred to as the “time periods”) may be set according to one or more characteristics of the endpoint or a network including the endpoint. For instance, the lengths of the time periods may be based on an operating system on the endpoint. The time periods may be set such that the first time period and/or the second time period are longer for endpoints that include macOS®, and/or shorter for endpoints that include WINDOWS® operating systems as described with reference to FIG. 2. Additionally or alternatively, the lengths of the time periods may be based on a number of programs operating on the endpoint. For example, the lengths of the time periods may decrease responsive to a large number of programs being run on the endpoint and increase responsive to a small number of programs being run on the endpoint. Additionally or alternatively, the lengths of the time periods may be based on network traffic experienced by a computer network in which an endpoint operates. The time periods may be shortened, for example, during times of heavy network traffic to prevent straining the computer network or lengthened during times of low network traffic. In these and other embodiments, the second time period may be substantially similar to the third time period and the first time period may be shorter than the second time period. In a non-limiting example, the third time period and the second time period may be about five minutes and the first time period may be about ten seconds.

In these and other embodiments, the time periods may be set by a user or an IT administrator. Additionally or alternatively, the time periods may be set based on properties of the error report and/or characteristics of the endpoint from which the log entries are collected. For example, a system implementing the method 300 may include a particular configuration that involves waiting a shorter period of time for the first time period if the endpoint operates on macOS® than if the endpoint operates on a MICROSOFT WINDOWS® operating system because the log file generated by a particular endpoint on macOS may be retained for shorter period of time than log files generated by a computer system using a MICROSOFT WINDOWS. As another example, the collection time intervals may be longer responsive to obtaining a particular error log entry that indicates applications on an endpoint are generally running at a slower rate.

In some embodiments, the collecting the one or more sets of log entries includes filtering the log entries. The log entries may be filtered during the first and/or the second time intervals by a parameter of the log entries. Accordingly, only a subset of the log entries may be collected during the first and/or the second time intervals that include the parameter. In some embodiments, the parameter includes an event category, an urgency level, an event domain, an application, a message or log prefix, a post identification number, a thread identification number, a time corresponding to the log entry, another log entry parameter, or combinations thereof.

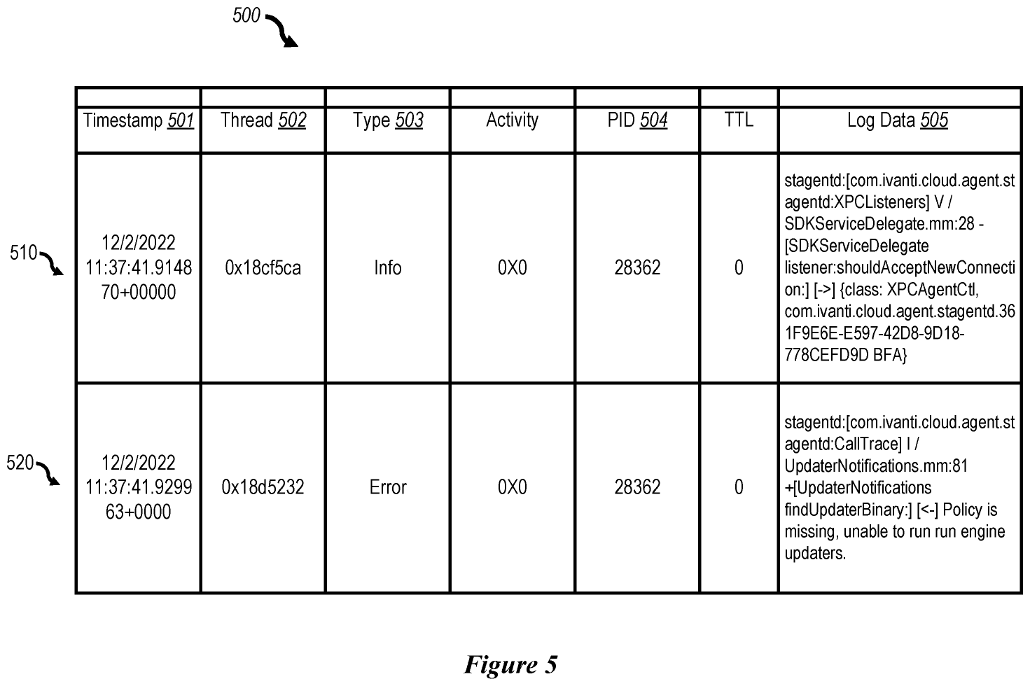

Accordingly, in these and other embodiments, the collecting the log entries may involve targeted log entry retrieval based on filtering the log files and collecting the log entries that satisfy particular filtering criteria. The log file generated by the endpoint may be filtered based on the text included in the log file. The log file may be filtered such that log entries that include a message prefix relating to errors (e.g., log files that include an [e] tag) and/or verbose log files (e.g., log files that include a [v] tag) are retrieved. As an additional or alternative example, the log file may be filtered such that log entries that relate to a specific application (e.g., “com.JohnDoeInc.remoteengine”) and/or log files that relate to a specific domain (e.g., “com.JohnDoeInc”) are retrieved. An example of a log entry and characteristics of the log entry by which the log file may be filtered are described in further detail in relation to FIG. 5 below.

At block 310, the sets of log entries or portions thereof may be aggregated. For instance, the collected sets of log entries, or combinations thereof may be aggregated or combined. At block 312, the aggregated log entries may be communicated. For instance, the aggregated log entry may be communicated to a particular storage location at an administrative device. At block 314, a mitigation action may be received. The mitigation action may be received from an administrative device. The mitigation action may be based on an analysis of the aggregated log entries and determination of a solution to the technical error. At block 316, the mitigation action may be implemented. The mitigation solution may implement the solution at the endpoint.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

FIG. 4 illustrates an example computer system 400 configured for log file collection and/or analysis according to at least one embodiment of the present disclosure. The computer system 400 may be implemented in the operating environments 100 FIGS. 1A and 1B, for instance. Examples of the computer system 400 may include the endpoints 102, the administrative device 106, the cloud computer system 108, the endpoint 102, the log file analysis system 214, or some combination thereof. The computer system 400 may include one or more processors 410, a memory 412, a communication unit 414, a user interface device 416, and a data storage 402 that includes one or more or a combination of the log files 206, the log file aggregation module 208, the log file analysis system 124, and/or the applications 204 (collectively, system modules).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some embodiments, the processor 410 may interpret and/or execute program instructions and/or process data stored in the memory 412, the data storage 402, or the memory 412 and the data storage 402. In some embodiments, the processor 410 may fetch program instructions from the data storage 402 and load the program instructions in the memory 412. After the program instructions are loaded into the memory 412, the processor 410 may execute the program instructions.

The memory 412 and the data storage 402 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some embodiments, the communication unit 414 may include one or more of an antenna, a wired port, and modulation/demodulation hardware, among other communication hardware devices. In particular, the communication unit 414 may be configured to receive a communication from outside the computer system 400 and to present the communication to the processor 410 or to send a communication from the processor 410 to another device or network (e.g., the cloud computer system 108 of FIG. 1B).

The user interface device 416 may include one or more pieces of hardware configured to receive input from and/or provide output to a user. In some embodiments, the user interface device 416 may include one or more of a speaker, a microphone, a display, a keyboard, a touch screen, or a holographic projection, among other hardware devices.

The system modules may include program instructions stored in the data storage 402. The processor 410 may be configured to load the system modules into the memory 412 and execute the system modules. Alternatively, the processor 410 may execute the system modules line-by-line from the data storage 402 without loading them into the memory 412. When executing the system modules, the processor 410 may be configured to perform one or more processes or operations described elsewhere in this disclosure.

Modifications, additions, or omissions may be made to the computer system 400 without departing from the scope of the present disclosure. For example, in some embodiments, the computer system 400 may not include the user interface device 416. In some embodiments, the different components of the computer system 400 may be physically separate and may be communicatively coupled via any suitable mechanism. For example, the data storage 402 may be part of a storage device that is separate from a device, which includes the processor 410, the memory 412, and the communication unit 414, that is communicatively coupled to the storage device. The embodiments described herein may include the use of a special-purpose or general-purpose computer including various computer hardware or software modules, as discussed in greater detail below.

FIG. 5 depicts a first example log entry 510 and a second example log entry 520 that may be implemented in the operating environments 100 of FIGS. 1A and 1B according to at least one embodiment of the present disclosure. The first example log entry 510 and the second example log entry 520 may be collected and compiled as a log file 500. The log file 500 illustrated in FIG. 5 may include the first example log entry 510, the second example log entry 520, and/or any other log entries generated by a particular managed endpoint. Additionally or alternatively, the log file 500 may include log entries generated by multiple different managed endpoints. For example, the first example log entry 510 may have been generated by a first managed endpoint, and the second example log entry 520 may have been generated by a second managed endpoint.

In some embodiments, the first example log entry 510 and the second example log entry 520 (collectively referred to herein as “the log entries 510, 520”) may include different types of information that may be analyzed by a reviewing user. As illustrated in the log file 500, the log entries 510, 520 indicate information relating to timestamps 501, threads 502, types 503, post identification numbers (PID) 504, and log data 505. The timestamp 501 indicates a date and/or a time at which a particular log entry is generated. The thread 502 indicates a thread of execution in a computer program associated with generation of the particular log entry. The type 503 indicates a categorization of the corresponding log entry, such as indicating whether a particular log entry provides information about a computer process running at the time of generation of the particular log entry or the particular log entry flags an error occurrence. The PID 504 indicates the specific post and/or thread that generated a particular log entry.

The log data 505 provides details regarding the event that triggered generation of the particular log entry. As illustrated in the log entries 510, 520, for example, the log data 507 specifies the particular applications that generated the log entries 510, 520. Additionally or alternatively, the log data 505 may provide a brief description of particular operations that resulted in generation of the log entries 510, 520.

Although only the aforementioned fields of information relating to the timestamp 501, the threads 502, the types 503, the PID 504, and the log data 505 are illustrated with respect to the log file 500, the log entries 510, 520 may include information relating to any other fields of information that may be helpful for a reviewing user in identifying errors and/or generally assessing network conditions. For example, the log file 500 may include a managed endpoint identifier, an identity of a user associated with the managed endpoint from which a particular log entry is obtained, a projected importance level of a particular log entry, some combination thereof, or any other fields of information. In these and other embodiments, the fields of information included in a particular log entry may be specified by the reviewing user so that the reviewing user receives relevant information from the log file 500. Additionally or alternatively, the fields of information included in a particular log entry may depend on the managed endpoint from which the particular log entry is obtained. A particular managed endpoint may generate log entries that include different fields of information depending on characteristics of the particular managed endpoint, such as system configuration settings, an operating system of the particular managed endpoint, application settings, or some combination thereof.

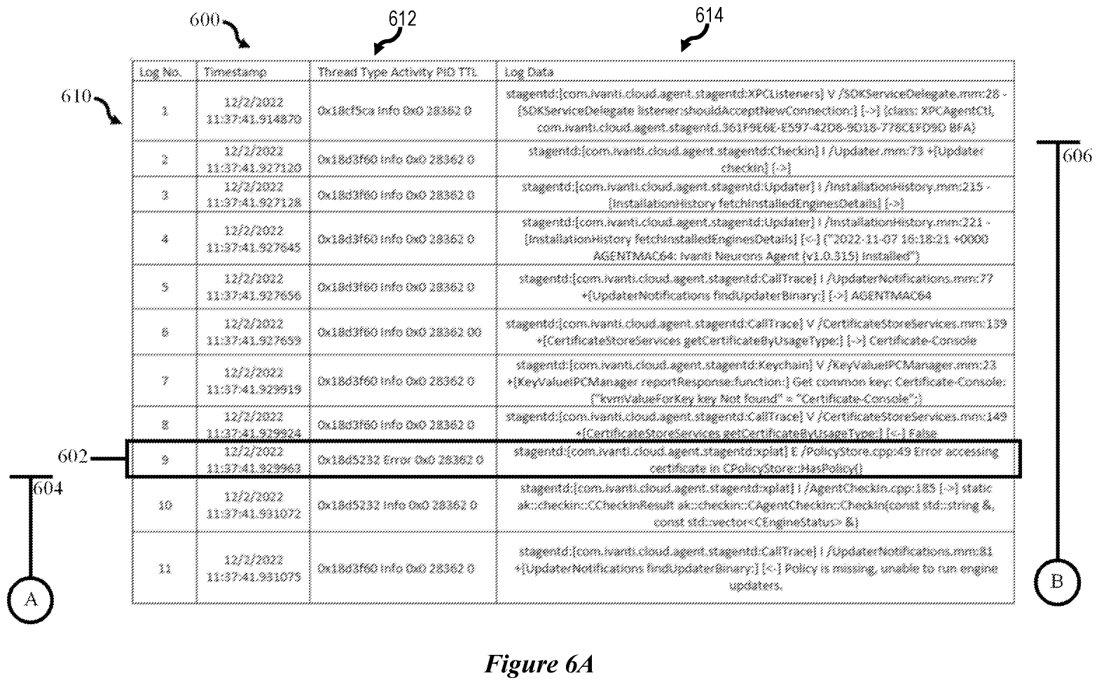

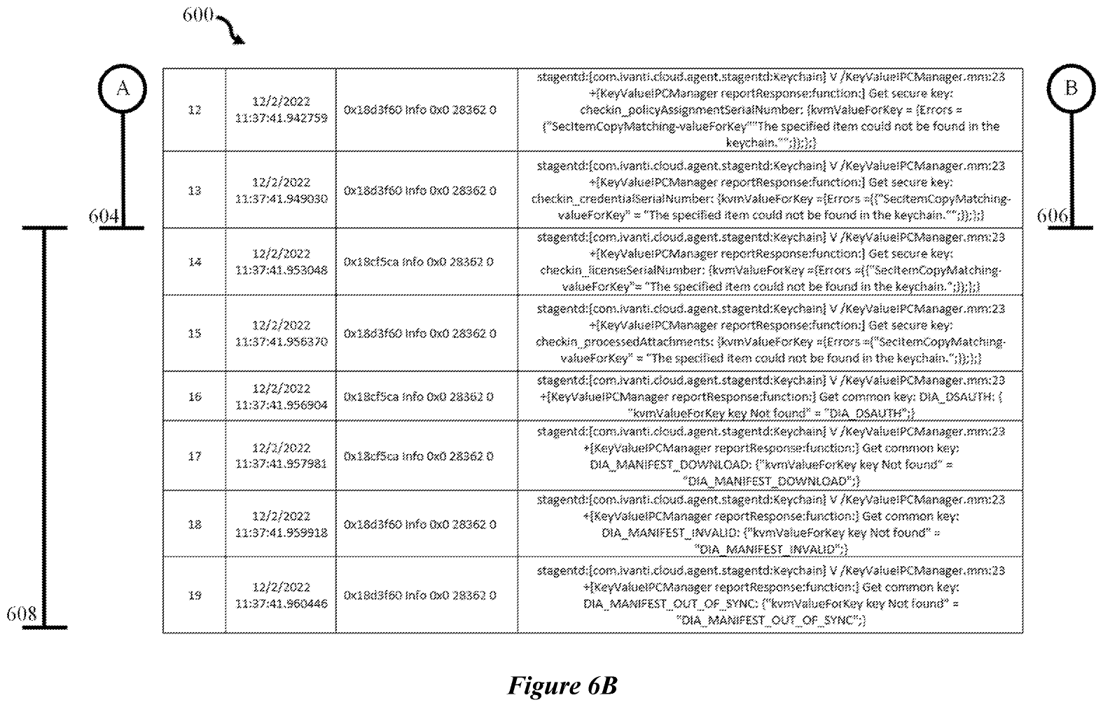

FIGS. 6A-6B depicts an example log file 600 depicting collected log entries according to at least one embodiment of the present disclosure. A log file aggregation module and/or a log file analysis system, such as the log file aggregation module 208 and/or the log file analysis system 214 described in relation to the operating environments 100 and/or the log file communication process 200 of FIGS. 1A, 1B, and 2, may be configured to perform operations with respect to the example log file 600 as described according to the operations of the method 300 described in relation to FIG. 3 and as illustrated in FIGS. 6A-6B.

The log file 600 may include log entries 610 that are generated based on operations performed by one or more endpoints. In some embodiments, the log entries 610 may include log entries from a single endpoint. Additionally or alternatively, the log entries 610 may include log entries from a group of endpoints. A log monitor command may be sent to an administrative device that implements the log file analysis system to initiate observation and analysis of the log file 600 in which analysis of the log file 600 begins with identification of an error log entry 602. In these and other embodiments, identification of the error log entry 602 may be facilitated by reviewing information included in the log entries 610. As illustrated in FIG. 6A, for example, an entry type field 612 of the log entries 610 may indicate whether a particular log entry 610 relates to erroneous process operations or information about a process performed on an endpoint.

In some embodiments, the log file aggregation module may initiate collection of a set of log entries based on identification of the error log entry 602. As illustrated in FIGS. 6A-6B, the log file aggregation module may ignore the log entries 610 that are generated during a first time period 604 following identification of the error log entry 602 so that duplicate error logs associated with the technical error that triggered the error log entry 602 may be avoided. Following the first time period 604, a first set of log entries may be collected during a first time interval 606 from the log file 600 in which the first time interval 606 begins at the end of the first time period 604 and goes back a second time period. The log file aggregation module may additionally or alternatively collect a second set of log entries over a second time interval 608 that begins at the end of the first time period 604 and moves forward for a third time period.

Additionally or alternatively, the log entries 610 may be filtered based on one or more characteristics of the log entries 610. For example, the log entries 610 may be filtered according to information included in a log data 614 field, such as only including log entries 610 that include stagentd text including “com.ivanti.cloud.agent”, “key Not found”, or any other text strings.

The first set of log entries and the second set of log entries may be aggregated and sent to the administrative device for analysis, such as by the log file analysis system. Based on the analysis of the aggregated log entries, a mitigation action may be determined by the administrative device. In some embodiments, the mitigation action may be based on an analysis of the aggregated log entries and represent a solution to the technical error associated with the error log entry 602. The mitigation action may be sent to the endpoint to which the error log entry 602 corresponds to implement the solution at the endpoint.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
monitoring a log file at an endpoint of a managed network, the log file including one or more log entries generated by the endpoint;
while monitoring the log file, identifying an error log entry that indicates a technical error is experienced at the endpoint;
ignoring the log entries that are generated during a first time period following identification of the error log entry, wherein the first time period is configured to reduce a duplicate error log associated with the technical error;
after the first time period:
collecting a first plurality of log entries during a first time interval from the endpoint, the first time interval beginning at the end of the first time period and going back a second time period; and
collecting a second plurality of log entries during a second time interval from the endpoint, the second time interval beginning at the end of the first time period and moving forward for a third time period;
aggregating the first and the second pluralities of log entries;
receiving a mitigation action from an administrative device, the mitigation action being based on an analysis of the aggregated log entries and determination of a solution to the technical error; and
implementing the mitigation action to implement the solution at the endpoint.

2. The method of claim 1, further comprising receiving a log monitor command configured to initiate the monitoring of the log file at the endpoint.

3. The method of claim 2, wherein the log monitor command is received from the administrative device in response to an error report that indicates an occurrence of the technical error at the endpoint.

4. The method of claim 1, wherein:
the second time period is substantially similar to the third time period; and
the first time period is shorter than the second time period.

5. The method of claim 4, wherein:
the second time period is about five minutes; and
the first time period is about ten seconds.

6. The method of claim 1, wherein the first time period, the second time period, and the third time period are set according to a characteristic of the endpoint.

7. The method of claim 1, further comprising communicating the aggregated log entries to a particular storage location at an administrative device.

8. One or more non-transitory computer-readable storage media configured to store instructions that, in response to being executed, cause a system to perform operations, the operations comprising:
monitoring a log file at an endpoint of a managed network, the log file including one or more log entries generated by the endpoint;
while monitoring the log file, identifying an error log entry that indicates a technical error is experienced at the endpoint;
ignoring the log entries that are generated during a first time period following identification of the error log entry, wherein the first time period is configured to reduce a duplicate error log associated with the technical error;
after the first time period:
collecting a first plurality of log entries during a first time interval from the endpoint, the first time interval beginning at the end of the first time period and going back a second time period; and
collecting a second plurality of log entries during a second time interval from the endpoint, the second time interval beginning at the end of the first time period and moving forward for a third time period;
aggregating the first and the second pluralities of log entries;
receiving a mitigation action from an administrative device, the mitigation action being based on an analysis of the aggregated log entries and determination of a solution to the technical error; and
implementing the mitigation action to implement the solution at the endpoint.

9. The one or more non-transitory computer-readable storage media of claim 8, further comprising receiving a log monitor command configured to initiate the monitoring of the log file at the endpoint.

10. The one or more non-transitory computer-readable storage media of claim 9, wherein the log monitor command is received from the administrative device in response to an error report that indicates an occurrence of the technical error at the endpoint.

11. The one or more non-transitory computer-readable storage media of claim 8, wherein:
the second time period is substantially similar to the third time period; and
the first time period is shorter than the second time period.

12. The one or more non-transitory computer-readable storage media of claim 11, wherein:
the second time period is about five minutes; and
the first time period is about ten seconds.

13. The one or more non-transitory computer-readable storage media of claim 8, wherein the first time period, the second time period, and the third time period are set according to a characteristic of the endpoint.

14. The one or more non-transitory computer-readable storage media of claim 8, further comprising communicating the aggregated log entries to a particular storage location at an administrative device.

15. A system comprising:
one or more processors; and
one or more non-transitory computer-readable storage media configured to store instructions that, in response to being executed, cause the system to perform operations, the operations comprising:
monitoring a log file at an endpoint of a managed network, the log file including one or more log entries generated by the endpoint;
while monitoring the log file, identifying an error log entry that indicates a technical error is experienced at the endpoint;
ignoring the log entries that are generated during a first time period following identification of the error log entry, wherein the first time period is configured to reduce a duplicate error log associated with the technical error;
after the first time period:
collecting a first plurality of log entries during a first time interval from the endpoint, the first time interval beginning at the end of the first time period and going back a second time period; and
collecting a second plurality of log entries during a second time interval from the endpoint, the second time interval beginning at the end of the first time period and moving forward for a third time period;
aggregating the first and the second pluralities of log entries;
receiving a mitigation action from an administrative device, the mitigation action being based on an analysis of the aggregated log entries and determination of a solution to the technical error; and
implementing the mitigation action to implement the solution at the endpoint.

16. The system of claim 15, further comprising receiving a log monitor command configured to initiate the monitoring of the log file at the endpoint.

17. The system of claim 16, wherein the log monitor command is received from the administrative device in response to an error report that indicates an occurrence of the technical error at the endpoint.

18. The system of claim 15, wherein:
the second time period is substantially similar to the third time period; and
the first time period is shorter than the second time period.

19. The system of claim 15, wherein:
the second time period is about five minutes; and
the first time period is about ten seconds.

20. The system of claim 15, wherein the first time period, the second time period, and the third time period are set according to a characteristic of the endpoint.
